(19) United States
(12) Patent Application Publication
(10) Pub. No.: US 2013/0073383 A1
(43) Pub. Date: Mar. 21, 2013

(54) BROADCASTING ADVERTISEMENT, PROMOTION, OR COUPON

(71) Applicant: Robert M. Uyeki, Torrance, CA (US)

(72) Inventor: Robert M. Uyeki, Torrance, CA (US)

(73) Assignee: Honda Motor Co., Ltd., Tokyo (JP)

(21) Appl. No.: 13/236,831

(22) Filed: Sep. 20, 2011

(51) Int. Cl. G06Q 30/00

(52) U.S. Cl. 705/14.49

(57) ABSTRACT

An interactive model may be provided for defining an advertisement, a promotion, or a coupon (“commercial message”) and a corresponding audience criteria. A database of audience members may be checked to determine who, among the audience members, satisfy the defined audience criteria and whether the satisfying audience members, collectively, satisfy a particular criteria. If the particular criteria is satisfied, the commercial message may be broadcast. Otherwise, a user may be permitted to redefine the audience criteria. In variations of embodiments: vehicle identifying information may be collected and an association between the vehicle identifying information and an identity of a vehicle owner may be created; vehicle condition information may be collected and stored in a database; demographic information regarding vehicle owners may be collected and stored in a database; and usage patterns may be tracked, trend analysis may be performed and aspects of a commercial message may be refined.

### BACKGROUND OF THE INVENTION

1. Field of the Invention

A system and method are provided for broadcasting a specific message to a user. In particular, a system and method are provided that allows advertisers to track and modify advertisements, promotions, or coupons and test effectiveness of the advertisements, the promotions, or the coupons.

2. Description of Related Art

A coupon can be exchanged for a discount or rebate when a consumer purchases a product. Generally, coupons are issued by manufacturers or retailers and are traditionally distributed via mail, magazines, newspapers and the like.

In addition to the above-mentioned traditional methods of distributing advertisements, promotions, and coupons, distribution may also be performed electronically via one or more networks, including, but not limited to, the Internet, as well as other networks. Advertisements, promotions, and coupons may be delivered to a consumer's computing device, such as, for example, a desktop personal computer (PC), a laptop PC, a mobile telephone, a personal digital assistant (PDA), or other computing device.

Although, electronically sent advertisements, promotions, and coupons may reach a broader audience as did traditional distribution methods, advertisers desire more precise methods of distributing the advertisements, the promotions, and the coupons to specific demographic groups.

### SUMMARY OF THE INVENTION

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

In various embodiments, an interactive advertisement model may be provided. A user, such as an advertiser or other user, may define an audience criteria for an advertisement, a promotion, or a coupon. Exemplary audience criteria may include, but not be limited to: people with incomes greater than a specific annual salary; households with children younger than a certain age; and people over a particular age with an annual income in a certain range. A database of audience members may be checked to determine who, among the audience members, satisfy the defined audience criteria. A determination may be made regarding whether the audience members who satisfy the defined audience criteria also satisfy a particular criteria. For example, assume that the particular criteria is defined to be a specific minimum number of people. If the audience criteria is defined as audience members with incomes greater than a specific annual salary, then if a number of audience members who satisfy the audience criteria (i.e., number of audience members with incomes greater than a specific annual salary) also satisfy the particular criteria (i.e., at least a specific number of audience members who satisfy the audience criteria), the advertisement, the promotion, or the coupon may be broadcast. Otherwise, the user may be permitted to redefine the audience criteria.

In some embodiments, a system is provided that includes at least one processor and a memory operatively connected to the at least one processor. The memory may include instructions and data, such that when the at least one processor executes the instructions and reads the data, the at least one processor performs a method. The system may receive a definition of an audience criteria for an advertisement, a promotion, or a coupon and may check a database of audience information for audience members who satisfy the audience criteria. The system may permit a redefining of the audience criteria when a particular criteria is not satisfied with respect to the audience members who satisfy the audience criteria. The system may then repeat the checking of the database of audience information to determine whether the audience members who satisfy the redefined audience criteria also satisfy the particular criteria. When the particular criteria is satisfied, the advertisement, the promotion, or the coupon may be sent electronically to the audience members who satisfy the audience criteria.

In one variation, vehicle identifying information may be collected and an association between the vehicle identifying information and an identity of a vehicle owner may be created, such that certain advertisements, promotions, or coupons may be distributed to audience members who own a particular type of vehicle.

In another variation, vehicle condition information may be collected and stored in a database, such that certain advertisements, promotions, or coupons may be distributed to audience members who own a particular type of vehicle in a specific condition.

In a third variation, demographic information regarding vehicle owners may be collected and stored in a database. In one embodiment, the demographic information may be received from mobile computing devices of the vehicle owners.

In a fourth variation, advertisement usage patterns may be tracked, trend analysis may be performed with respect to the tracked usage patterns and aspects of an advertisement, promotion, or coupon may be refined based on the performed trend analysis.

### BRIEF DESCRIPTION OF THE DRAWINGS

FIG. 1 is a functional block diagram of an exemplary computing device that may implement aspects of various embodiments.

FIG. 2 illustrates an exemplary operating environment for a number of embodiments.

FIG. 3 is an example of an advertisement database that may be used in various embodiments.

FIG. 4 shows an example of a user database that may be used in some embodiments.

FIG. 5 is a flowchart illustrating exemplary processing that may be performed in some embodiments.

FIG. 6 is a flowchart illustrating exemplary processing that may be performed in another embodiment.

FIG. 7 is a flowchart illustrating exemplary processing that may be performed in a third embodiment.

FIG. 8 shows an exemplary usage database that may be used in some embodiments.

FIG. 9 is a flowchart illustrating an exemplary process, in some embodiments, for creating an association between vehicle identifying information and an identity of a vehicle owner.

FIG. 10 illustrates exemplary processing in an embodiment in which demographic information may be received from vehicle owners.

### DETAILED DESCRIPTION

### 1. Overview

A method and system is provided for an interactive advertisement model in which an advertisement, promotion, or coupon may be broadcast to a targeted audience. In one embodiment, an advertisement, promotion, or coupon may be defined. An audience criteria may be defined to specify information, or attributes, regarding desired targeted audience members. A user database may be checked to determine audience members who satisfy the audience criteria and whether a number of audience members who satisfy the audience criteria satisfy a particular criteria. The particular criteria may include, but not be limited to, a minimum number of audience members who satisfy the audience criteria. If the particular criteria is satisfied, then the advertisement, the promotion, or the coupon may be electronically sent to the audience members who satisfy the audience criteria. Otherwise, a user may adjust, or redefine, the audience criteria and the process may be repeated to determine whether audience members who satisfy the redefined audience criteria also satisfy the particular criteria.

In a variation of the embodiment, the advertisement, promotion, or the coupon may be checked to determine if the advertisement, the promotion, or the coupon is time sensitive. If the advertisement, the promotion, or the coupon is determined to be time sensitive, then, for each audience member who satisfies the audience criteria, location information with respect to the audience member may be obtained and broadcasting of the advertisement, the promotion, or the coupon may be time adjusted in consideration of the time sensitivity.

In a second variation of the embodiments, usage information regarding the advertisement, the promotion, or the coupon may be tracked and a trend analysis may be performed to determine any trends as a result of sending the advertisement, the promotion, or the coupon. Results of the trend analysis may be presented to a user.

In some variations of the embodiments, vehicle identifying information may be collected and an association between the vehicle identifying information and an identity of a vehicle owner may be created. As a result, advertisements, promotions, or coupons may be targeted to audience members who own a particular type of vehicle. Some variations may receive demographic information from the vehicle owners and may store the demographic information in a database, such that advertisements, promotions, or coupons may be targeted to audience members who own a particular type of vehicle and are within a specific demographic.

In some embodiments, demographic information may be received from a vehicle owner via a computing device. The computing device may including, but not limited to a mobile telephone, a PDA, a laptop PC, an in-vehicle device, a desktop PC or other computing device.

### 2. Exemplary Computing Device

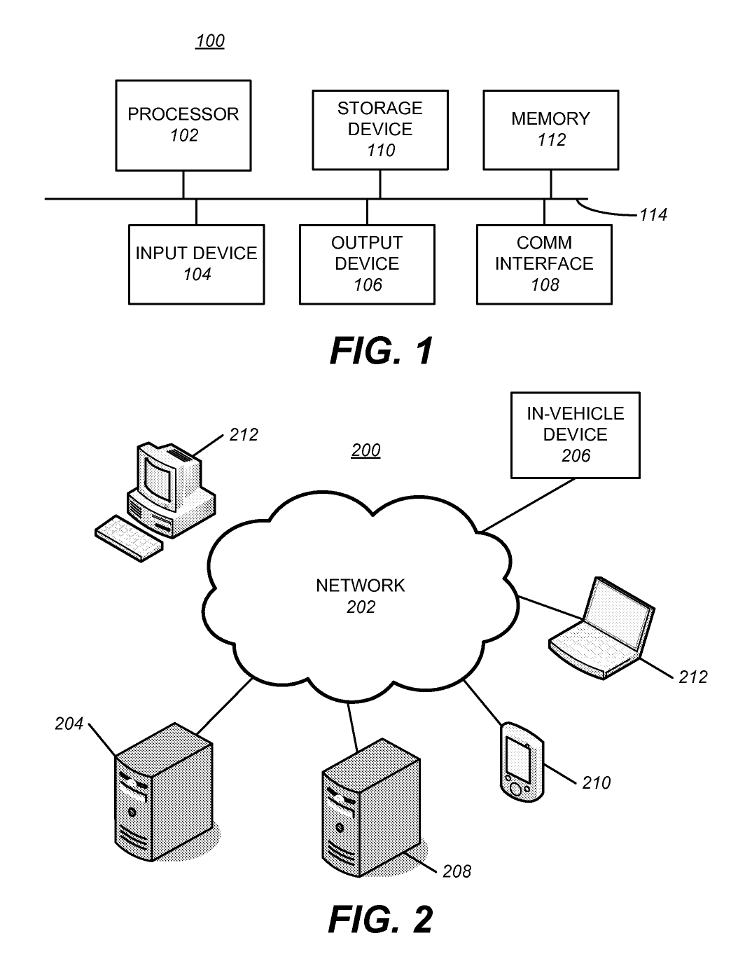

FIG. 1 is a functional block diagram illustrating an exemplary computing device which may implement aspects of a number of embodiments. Computing device 100 may include a bus 114, an input device 104, a processor 102, a memory 112, which may include a random access memory (RAM) and a read only memory (ROM), a storage device 110, an output device 106, and a communication interface 108. Bus 114 may permit communication between processor 102 and components of computing device 100.

Processor 102 may include at least one conventional processor or microprocessor that interprets and executes instructions. The RAM may be a random access memory or another type of dynamic storage device that stores information and instructions for execution by processor 102. The RAM may also store temporary variables or other intermediate information used during execution of instructions by processor 102. The ROM may include a conventional ROM device or another type of static storage device that stores static information and instructions for processor 102. Storage device 110 may include any type of computer-readable storage medium for storing data and/or instructions.

Input device 104 may include one or more conventional mechanisms that permit a user to input information to computing device 100, such as, for example, a keyboard, a touch screen, or other input device. Output device 106 may include, but not be limited to, a display device, a printer, a speaker, or other output device. Communication interface 108 may include any transceiver-like mechanism that enables computing device 100 to communicate with other devices or networks.

Computing device 100 may perform such functions in response to processor 120 executing sequences of instructions contained in a machine-readable storage medium, such as, for example, RAM, ROM, an optical storage medium, a magnetic storage medium, or other machine-readable storage medium. Such instructions may be read into the RAM from another machine-readable storage medium, such as storage device 110, or from a separate device via a communication medium.

### 3. Exemplary Operating Environment

FIG. 2 illustrates an exemplary operating environment 200 for various embodiments. Exemplary operating environment 200 may include a network 202 and computing devices 204-214. Computing devices 204 and 208 may be personal computers or servers having one or more databases. Computing device 206 may be an in-vehicle device including, but not limited to, an in-vehicle navigation system. Computing device 212 may include a laptop PC. Computing device 210 may include a PDA or a mobile telephone. Computing device 212 may include a desktop PC. Network 202 may include a single network or a network of networks. Network 202 may be a wireless network, a wired network, or a combination of one or more wireless networks and one or more wired networks.

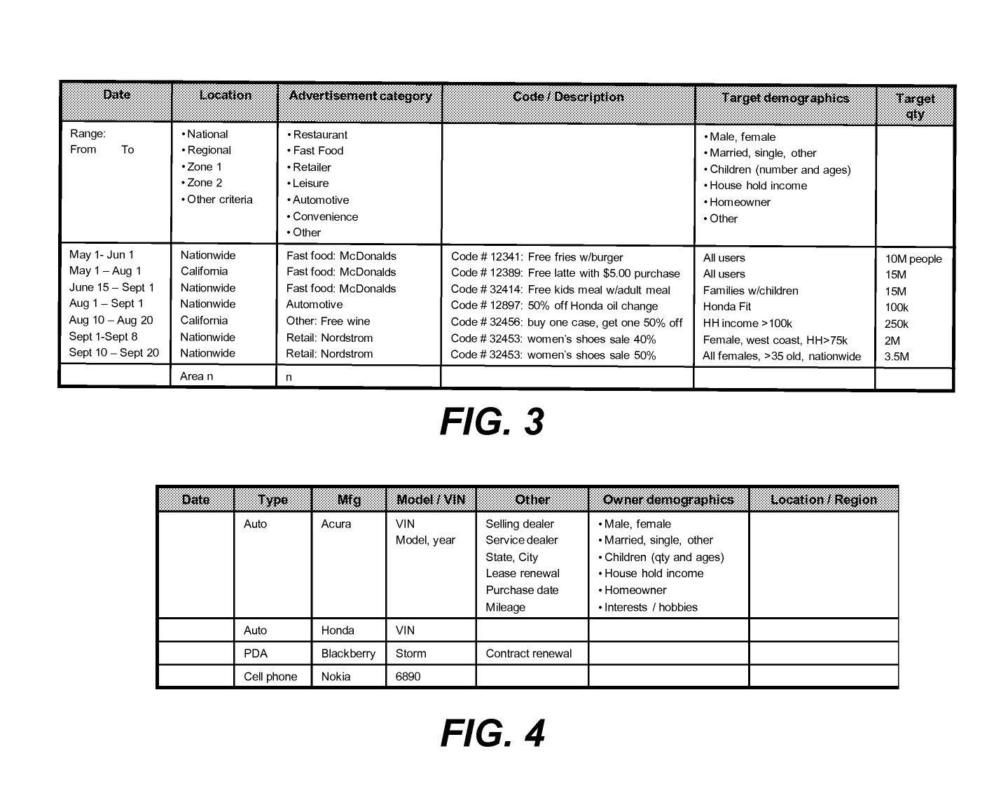

FIG. 3 illustrates an exemplary advertisement database that may be used in various implementations. The exemplary advertisement database may include information regarding advertisements, promotions, or coupons (“commercial messages”), including, but not limited to, a date range for each commercial message, a location or zone where each commercial message may be presented, a category of a commercial message, a code or description regarding a commercial message, target demographics regarding a commercial message, and a target quantity with respect to targets of the commercial message. Exemplary information that may be stored in the exemplary advertisement database of FIG. 3 include: a nationwide coupon for McDonald's, good from May 1-June 1, for free fries with the purchase of a burger, targeted to all users, wherein a target quantity is at least 10 million people; a coupon for McDonald's in California, good from May 1-August 1, for a free latte with a $5.00 purchase, targeted to all users, wherein a target quantity is at least 15 million people; a nationwide coupon for McDonald's, good from June 15-September 1, a coupon for a free kid's meal with the purchase of an adult meal, targeted to families with children, wherein a target quantity is at least 15 million people; a nationwide coupon good at Honda dealers from August 1-September 1, 50% off the price of an oil change, targeted to people who own a Honda Fit, with a target quantity of at least 100,000 people; a California coupon, good from August 10-August 20, for 50% off the price of a second bottle of wine when a first bottle is purchased at full price, targeted to people with a household income greater than $100,000, wherein a target quantity is at least 250,000 people; an advertisement for a nationwide Nordstrom sale from September 1-September 8, advertising 40% off the price of women's shoes, targeted to females located on the West Coast with a household income greater than $75,000, wherein a target quantity is at least 2 million people; and a nationwide advertisement for a Nordstrom sale from September 10-September 20, advertising 50% off the price of women's shoes, targeted to females, nationwide, who are over 35 years of age, wherein a target quantity is 3.5 million.

Content of the above-mentioned advertisement database is exemplary. In various embodiments, an advertisement database may include other types of data with values different from the values shown in FIG. 3.

FIG. 4 illustrates an exemplary user database that may be used in various embodiments. The user database may include information such as, for example, a date the information was last updated, a type of information, manufacturer, model/VIN other information, owner demographics, and location/region information. Type information may indicate whether the information pertains to an owner's automobile, personal digital assistant (PDA), a mobile telephone, or other type. Manufacturer refers to a manufacturer with respect to the automobile, the PDA, the mobile telephone, or the other type. Model/VIN may refer to a vehicle identification number when type indicates automobile or a model number with respect to a PDA, a cell phone or other type. Other may refer to other information with respect to the type such as, for example, selling dealer, service dealer, state, city, lease renewal, purchase date and mileage with respect to an automobile type; contract renewal information with respect to a PDA type or a mobile telephone type, or information with respect to another type. Owner demographics may include, but not be limited to, an owner's gender, an owners marital status, a number of children an owner has, ages of an owner's children, household income, whether an owner is a homeowner, and an owner's interests or hobbies.

### 4. Exemplary Processing

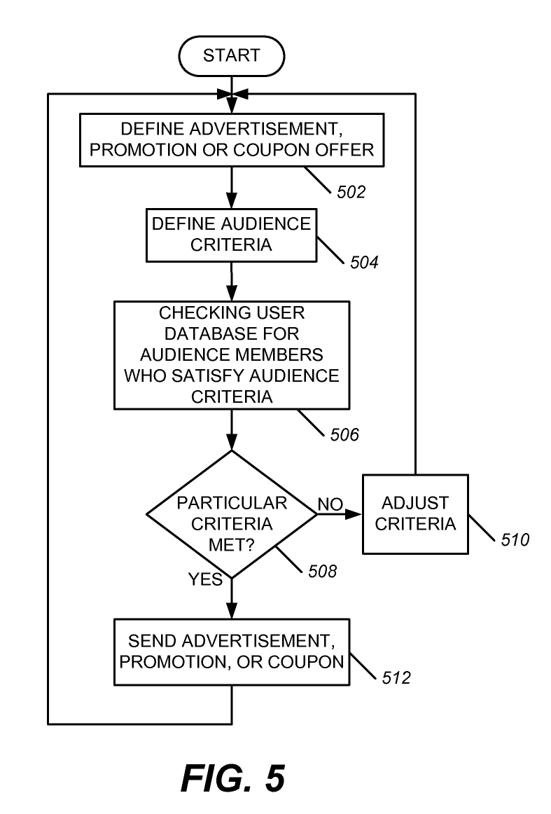

FIG. 5 is a flowchart that illustrates exemplary processing by one or more computing devices in various embodiments. The process may begin with a user of an embodiment providing input defining an advertisement, promotion, or coupon offer (act 502). For example, the user may define the advertisement, the promotion, or the coupon offer as an entry in an advertisement database.

Next, the user may provide input defining an audience criteria, or a target audience for the advertisement (act 504). The audience criteria may include, but not be limited to, a target audience member's age or age range, a location or zone, a household income, number of children, a duration of the advertisement, as well as other or different audience criteria. The one or more computing devices may then check a user database for audience members who satisfy the audience criteria (act 506).

The one or more computing devices may then determine whether the audience members who satisfy the audience criteria also satisfy a particular criteria (act 508). Non-limiting examples of a particular criteria may include: 250,000 people who live in zone 1 and have vehicles older than five years of age; 100,000 people with a household income greater than $250,000 distributed evenly across the nation; 750,000 households in zone 2 with children aged 1-10 years; and 500,000 people over 50 years of age who live in California and have an annual income in a range of $15,000-$75,000.

If the audience members who satisfy the audience criteria do not satisfy the particular criteria, then the one or more computing devices may prompt and receive, from the user, a redefined, or adjusted, audience criteria (act 508). The redefined, or adjusted, audience criteria may include a different advertisement duration, a change with respect to a location/zone, a change in a target audience member age or age range, a changed income criteria, or other criteria. Act 502-508 may again be performed.

If, during act 508, the one or more computing devices determines that the audience members who satisfy the audience criteria satisfy the particular criteria, then the advertisement, promotion, or coupon offer may be sent, or broadcast (act 512). In some embodiments, the advertisement, promotion, or coupon offer may be broadcast via a broadcast server to a computing device including, but not limited to, an in-vehicle computing device, a mobile telephone, a PDA, a desktop personal computer, a laptop or notebook computer, or other computing device. In some embodiments, the in-vehicle computing device may include a navigation unit.

In some embodiments, an advertisement, promotion, or coupon offer may be time sensitive. For example, a time sensitive advertisement, promotion, or coupon offer may be related to breakfast, lunch, happy hour, or dinner related categories.

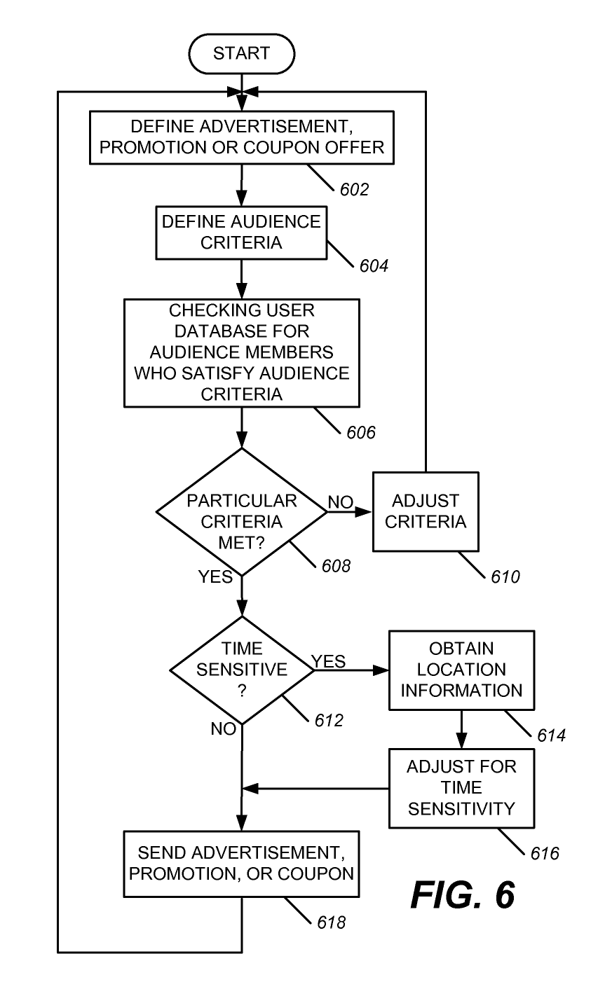

FIG. 6 is a flowchart illustrating exemplary processing by one or more computing devices in an embodiment that considers time sensitivity of an advertisement, a promotion, or a coupon offer. The process may begin with a user of an embodiment providing input to one or more computing device for defining an advertisement, promotion, or coupon offer (act 602) and for defining an audience criteria (act 604). The one or more computing devices may then check a user database for audience members who satisfy the defined audience criteria (act 606).

If a particular criteria is not met by the audience members who satisfy the audience criteria, then the one or more computing devices may prompt the user and may receive an adjusted, or redefined audience criteria (act 610) and act 602-608 may again be performed. Otherwise, the one or more computing devices may determine whether the advertisement, the promotion, or the coupon offer is time sensitive (act 612). If the advertisement, the promotion, or the coupon is time sensitive, then the one or more computing devices may obtain location information with respect to the advertisement, the promotion, or the coupon offer (act 614) and may adjust for time sensitivity (act 616). As an example, if a defined advertisement is related to breakfast, but a current time is 12 noon in a time zone of a location included in the defined advertisement, the advertisement may either be deleted or rescheduled to be broadcast a next morning to the location.

If the advertisement, the promotion, or the coupon is determined, during act 612, to not be time sensitive, or the advertisement, the promotion, or the coupon has been adjusted for time sensitivity (act 616), then the one or more computing devices may send or broadcast the advertisement, the promotion, or the coupon offer (act 618). The one or more computing devices may again perform act 602-608.

In some embodiments, an interactive advertisement/promotion/coupon model may track usage patterns of an advertisement, a promotion, or a coupon offer for trend analysis. As an example, users may make requests via a computing device for particular types of advertisements, promotions, or coupon offers. Embodiments may track the requests for the particular types of advertisements, promotions, or coupon offers.

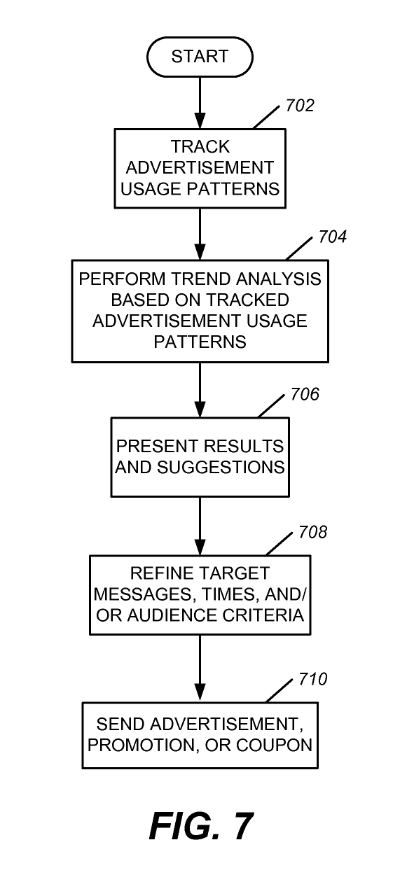

FIG. 7 is a flowchart illustrating exemplary processing in an embodiment in which usage patterns may be tracked. The process may begin with one or more computing devices tracking usage patterns of advertisements, promotions, or coupon offers in an interactive model (act 702). The usage patterns may be stored in a usage database. The one or more computing devices may perform trend analysis based on the tracked usage patterns (act 704) and may present results and/or suggestions to a user of the embodiment (act 706). For example, results of the trend analysis may indicate that a certain type of advertisement, promotion, or coupon offer is requested at certain times by a particular demographic group in one or more locations. Results of the trend analysis may indicate an effectiveness, or lack thereof, with respect to an advertisement, a promotion, or a coupon offer regarding one or more demographic groups and/or one or more location zones.

The user may provide input to the one or more computing devices to refine the advertisements, the promotions, or the coupon offers, times for broadcasting the advertisements, the promotions, or the coupon offers, and/or refining the audience criteria based on the results of the trend analysis (act 708). In some embodiments, the one or more computing devices may automatically make the refinements based on the results of the trend analysis.

The one or more computing devices may then send or broadcast the refined advertisements, the refined promotions, or the refined coupon offers according to the refined times for broadcasting to audience members who satisfy the refined audience criteria (act 710).

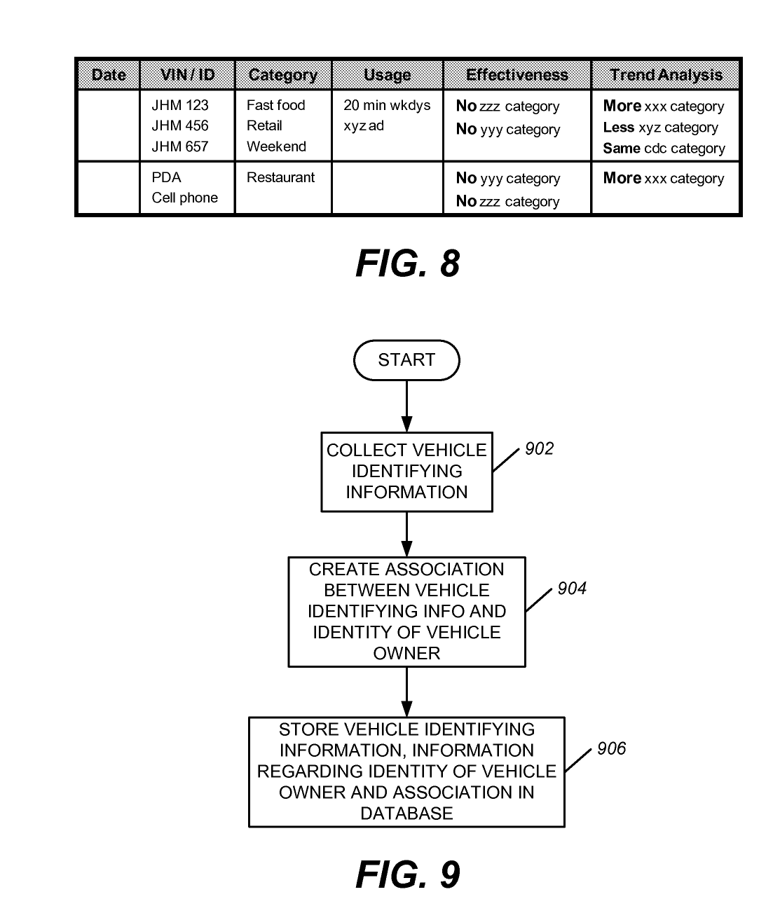

FIG. 8 illustrates exemplary content of an exemplary usage database, which may be employed in various embodiments. The usage database may include, but not be limited to, a date an entry was last updated, an ID, a VIN or a type, a category related to an advertisement, a promotion, or a coupon offer, usage information, effectiveness, and trend analysis. A first entry of the exemplary usage database includes an ID of “JHM 123”, a category of “fast food”, usage information of “20 minutes on weekdays”, effectiveness indicating that “no zzz category” advertisement, promotion, or coupon offer was requested, and a trend analysis indicating, or suggesting, having more advertisements, promotions, or coupon offers in an xxx category. A second entry of the exemplary usage database includes an ID of “JHM 456”, a category of “retail”, usage information indicating that an xyz advertisement was requested, effectiveness indicating that “no zzz category” advertisement, promotion, or coupon offer was requested, and a trend analysis indicating, or suggesting, having fewer advertisements, promotions, or coupon offers in an xyz category. A third entry of the exemplary usage database includes an ID of “JHM 657”, a category of “weekend”, and a trend analysis indicating, or suggesting, having a same amount of advertisements, promotions, or coupon offers in a cdc category. A fourth entry of the exemplary usage database includes a type of “PDA”, a category of “restaurant”, effectiveness indicating that “no yyy category” advertisements, promotions, or coupon offers were requested, and a trend analysis indicating, or suggesting, having more advertisements, promotions, or coupon offers in the xxx category. A fifth entry of the exemplary usage database includes a type of “cell phone”, and an effectiveness of “no zzz category”.

In some embodiments, an association between a vehicle and a vehicle owner may be created. FIG. 9 is a flowchart illustrating an exemplary processing by one or more computing devices in an embodiment in which an association is created between a vehicle and a vehicle owner. The process may begin with the one or more computing devices collecting the vehicle identifying information (act 902). Collecting of the vehicle identifying information may be performed by automobile dealers, vehicle owners, or others using a computing device. The one or more computing devices may then create an association between the collected vehicle identifying information and an identity of a vehicle owner (act 904). The one or more computing devices may store the vehicle identifying information, information regarding the identity of the vehicle owner, and information regarding an association between the vehicle identifying information and the identity of the vehicle owner in a database (act 906).

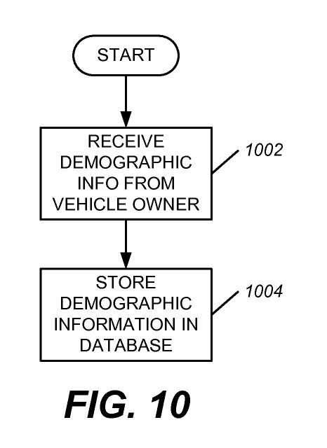

In some embodiments, demographic information may be received from vehicle owners and entered into a database via a computing device. FIG. 10 is a flowchart illustrating exemplary processing in embodiments in which demographic information is received from vehicle owners via respective computing devices. The process may begin with a computing device receiving demographic information from a vehicle owner who (act 1002). The demographic information may be provided to one or more computing devices, via a network, and may be stored in a database (act 1004). For example, a vehicle owner may enter demographic information via a computing device, including, but not limited to, a handheld computing device, a PDA, a smart phone, a vehicle navigation unit, a desktop computer, a notebook computer, or other computing device.

### 5. CONCLUSION

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Although the above descriptions may contain specific details, they are not to be con-strued as limiting the claims in any way. Other configurations of the described embodiments are part of the scope of this disclosure. In addition, acts illustrated by the flowcharts of FIGS. 5-7 and 9-10 may be performed in a different order in other embodiments, and may include additional or fewer acts. Accordingly, the appended claims and their legal equivalents define the invention, rather than any specific examples given.

1. A machine-implemented method for broadcasting a specific message to a user, the method comprising:
defining an audience criteria for an advertisement, a promotion, or a coupon;
checking a database for audience members who satisfy the audience criteria;
determining whether the audience members who satisfy the audience criteria satisfy a particular criteria;
permitting the audience criteria to be adjusted when the audience members who satisfy the criteria are determined to not satisfy the particular criteria; and
permitting the advertisement, promotion, or coupon to be broadcast only when the audience members who satisfy the audience criteria also satisfy the particular criteria, wherein
the machine-implemented method is performed by one or more computing devices.

2. The machine-implemented method of claim 1, further comprising:
collecting vehicle identifying information;
creating an association between the vehicle identifying information and an identity of a vehicle owner; and
storing the vehicle identifying information, information regarding the identity of the vehicle owner, and the association in the database.

3. The machine-implemented method of claim 2, further comprising:
collecting vehicle condition information, the vehicle condition information including vehicle identifying information; and
storing the collected vehicle condition information in the database.

4. The machine-implemented method of claim 1, further comprising:
receiving demographic information regarding vehicle owners; and
storing the demographic information in the database.

5. The machine-implemented method of claim 1, further comprising:
receiving demographic information from a vehicle owner via a mobile computing device; and
storing the demographic information in the database.

6. The machine-implemented method of claim 1, further comprising:
tracking advertisement usage patterns in a usage database; and
performing trend analysis based on the tracked advertisement usage patterns in the usage database.

7. The machine-implemented method of claim 6, further comprising:
refining aspects of the advertisement, promotion, or coupon based on the performed trend analysis.

8. A system for developing an advertisement model, the system comprising:
at least one processor; and
at least one memory operatively connected to the at least one processor; the at least one memory including instructions and data for the at least one processor to perform a method comprising:
receiving a definition of an audience criteria for an advertisement, a promotion, or a coupon;
checking a database of audience information for audience members who satisfy the audience criteria;
determining whether the audience members who satisfy the criteria also satisfy a particular criteria;
permitting a redefining of the audience criteria when the particular criteria is not satisfied; and
repeating the checking a database of audience information, and the determining whether the audience members who satisfy the criteria also satisfy a particular criteria after the permitting a redefining of the audience criteria.

9. The system of claim 8, wherein the method further comprises:
tracking advertisement usage patterns;
performing trend analysis based on the tracked advertisement usage patterns; and
presenting results of the trend analysis.

10. The system of claim 9, wherein the presented results of the trend analysis include suggestions for redefining the audience criteria to better satisfy the particular criteria.

11. The system of claim 8, wherein the method further comprises:
collecting vehicle identifying information;
creating an association between the vehicle identifying information and an identity of a vehicle owner; and
storing the vehicle identifying information, information regarding the identity of the vehicle owner, and the association in the database.

12. The system of claim 11, wherein the information regarding the identity of the vehicle owner includes demographic information.

13. The system of claim 8, wherein the method further comprises:
electronically transmitting an advertisement, a promotion, or a coupon when the audience members who satisfy the audience criteria also satisfy the particular criteria.

14. At least one machine readable storage medium having instructions recorded thereon for at least one processor, when the instructions are executed by the at least one processor a method is performed comprising:
receiving, by the at least one processor, a definition of an audience criteria for an advertisement, a promotion or a coupon;
checking, by the at least one processor, a database of audience information to determine whether a particular criteria are satisfied based on the defined audience criteria; and
permitting, by the at least one processor, a redefining of the audience criteria when the particular criteria is determined not to be satisfied.

15. The at least one machine-readable storage medium of claim 14, wherein the method further comprises:
detecting advertisement usage patterns based on a usage database; and
presenting information regarding the detected advertisement usage patterns.

16. The at least one machine-readable storage medium of claim 14, wherein the method further comprises:
tracking advertisement usage patterns in a usage database;
performing trend analysis based on the tracked advertisement usage patterns in the usage database; and
refining aspects of the advertisement, promotion, or coupon based on the trend analysis.

17. The at least one machine-readable storage medium of claim 14, wherein the method further comprises:
sending the advertisement, the promotion, or the coupon to audience members who satisfy the defined audience criteria when the particular criteria are determined to be satisfied based on the defined audience criteria.

18. The at least one machine-readable medium of claim 17, wherein the sending the advertisement, the promotion, or the coupon further comprises:
determining whether the advertisement, the promotion, or the coupon is time sensitive; and
sending the advertisement, the promotion, or the coupon during an appropriate time period, taking a local time zone into consideration, when the advertisement, the promotion, or the coupon is determined to be time sensitive.

19. The at least one machine-readable storage medium of claim 14, wherein the method further comprises:
collecting vehicle identifying information;
creating an association between the vehicle identifying information and an identity of a vehicle owner; and
storing the vehicle identifying information, information regarding the identity of the vehicle owner, and the association in the database.

20. The at least one machine-readable storage medium of claim 19, wherein the information regarding the identity of the vehicle owner includes demographic information.
